(19) United States
(12) Patent Application Publication
(10) Pub. No.: US 2005/0131883 A1
(43) Pub. Date: Jun. 16, 2005

(54) Browsing a list of data items

(75) Inventors: Robert F. Buxton, Chandlers Ford (GB); Richard M. W. Harran, Southampton (GB); Andrew I. Hickson, West Wellow (GB); Paul Hopewell, Chandlers Ford (GB); Stephen J. Kinder, Hyde Park, NY (US); Ian W. Parkson, Eastleigh (GB); Gary S. Puchkoff, Poughkeepsie, NY (US); James H. Warnes, Hopewell Junction, NY (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 11/005,805

(22) Filed: Dec. 7, 2004

(30) Foreign Application Priority Data
Dec. 10, 2003 (GB) 0328576.4

(51) Int. Cl. G06F 17/30

(52) U.S. Cl. 707/3

(57) ABSTRACT

An apparatus includes a browse mechanism to scan a list of data items. A marker is applied to the data items once they have been scanned by the browse mechanism. The marker provides an indication that a respective data item has been scanned by a given browse entity. The browse mechanism subsequently scans only unmarked data items in the list of data items.

### BACKGROUND OF THE INVENTION

This invention relates to the field of browsing data items in a list, and more particularly, to identifying different cooperating groups of browser mechanisms.

A list of data items to be browsed is provided. The list can be any collection of data items which may be built on the fly or may pre-exist. A list of data items is defined in a broad sense which can include a database, a list of files, a messaging queue, pages from an online system such as the Internet, etc.

Browsing a list of data items involves scanning through the list of data items or references to the data items. Browsing involves observing the data in the list in a non-destructive manner. A browser scans through the list reading all or part of the data items without removing or changing the data. A browser can copy data items during browsing but does not destroy or alter the original list of data items being browsed.

Browsing may be carried out to identify a specific data item, to search for data items that match search criteria, or to locate anything that looks to be of interest where the browser reads part of the data item or a heading and decides on the fly if it is of interest.

A browser may establish what data items exist on a list and may organise the data items, for example, by allocating the data items to other processor threads to carry out actions on the data items. Other processor threads may actually remove the data items from the list in order to process them.

A list of data items can include the data items in an order according to a wide number of systems. Data items may be prioritised in a certain order, they may be chronological, alphabetical, by subject, etc. This means that a data item that is added to a list may be added in any position in the list.

A browser may browse through the data items in the order they are given in the list, or in another order determined by the browser. Meanwhile, data items may be added to the list in front of the browser or behind the browser. Those browsers which have passed the position in which a new data item has been added, must go back to browse the new data item.

More than one browser can scan the same list of data items at the same time. For example, the list of data items may be a messaging queue which can be accessed by more than one client application.

### BRIEF SUMMARY OF THE INVENTION

According to one aspect of the present invention, a method of browsing a list of data items comprises scanning through a list of data items, providing a marker to data items once they have been scanned, the marker providing an indication that a respective data item has been scanned by a given browse entity, and subsequently scanning through only unmarked data items in the list of data items.

According to another aspect of the present invention, an apparatus for browsing a list of data items comprises a browse mechanism to scan a list of data items and a marker applied to data items once they have been scanned by the browse mechanism. The marker provides an indication that a respective data item has been scanned by a given browse entity. The browse mechanism subsequently scans only unmarked data items in the list of data items.

According to yet another aspect of the present invention, a computer program product comprising a computer readable medium having computer readable program code embodied therein. The computer readable program code comprises computer readable program code configured to scan through a list of data items, computer readable program code configured to provide a marker to data items once they have been scanned, the marker providing an indication that a respective data item has been scanned by a given browse entity, and computer readable program code configured to scan subsequently through only unmarked data items in the list of data items.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a block diagram of a messaging system;

FIG. 2 is a block diagram of a messaging system with a shared queue;

FIG. 3 is a schematic diagram of a list of data items being browsed;

FIGS. 4A and 4B are schematic diagrams of lists of data items with markers in accordance with an aspect of the present invention; and

FIG. 5 is a schematic diagram of a system for marking a list of data items in accordance with an aspect of the present invention.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The embodiments described herein are given in the context of a messaging environment, specifically WebSphere® MQ messaging (formerly known as MQSeries®). WebSphere® and MQSeries® are trademarks of International Business Machines Corporation in the United States, other countries, or both. Details of WebSphere MQ messaging are provided at <www.ibm.com/software/integration/wmq>. As stated above, the invention could equally be applied to other applications and environments in which there is a list of data items to be scanned or browsed.

Messaging and queuing enables applications to communicate without having a private connection to link them. Applications communicate by putting messages on message queues and by taking messages from message queues. The communicating applications can be running on the same processor in a single environment, on the same processor in different environments, or on different processors in different environments.

An application talks directly to a local queue manager on the same processor as the application itself using the Message Queue Interface (MQI). The MQI is a set of calls that applications use to ask for the services of a queue manager. There are two basic operations: put a message on a queue (using the MQPUT call), and take a message from a queue (using the MQGET call).

Messages can be ordered in the queue in a number of ways. The most frequently used ordering systems in messaging queues are the first in, first out (FIFO) system and the priority ordering system. Priority ordering puts the messages in an order in the queue according to a pre-determined priority system. For example, messages from a particular client application may be given a higher priority than those from another application and therefore the ordering reflects from which client application the messages have originated.

A message queue is one form of list of data items to which the present invention may be applied. In the context of other forms of lists of data items, for example, such as databases, ordering can take many forms. For example, ordering in a database may be alphabetical, chronological, by subject, by label, by contents, etc.

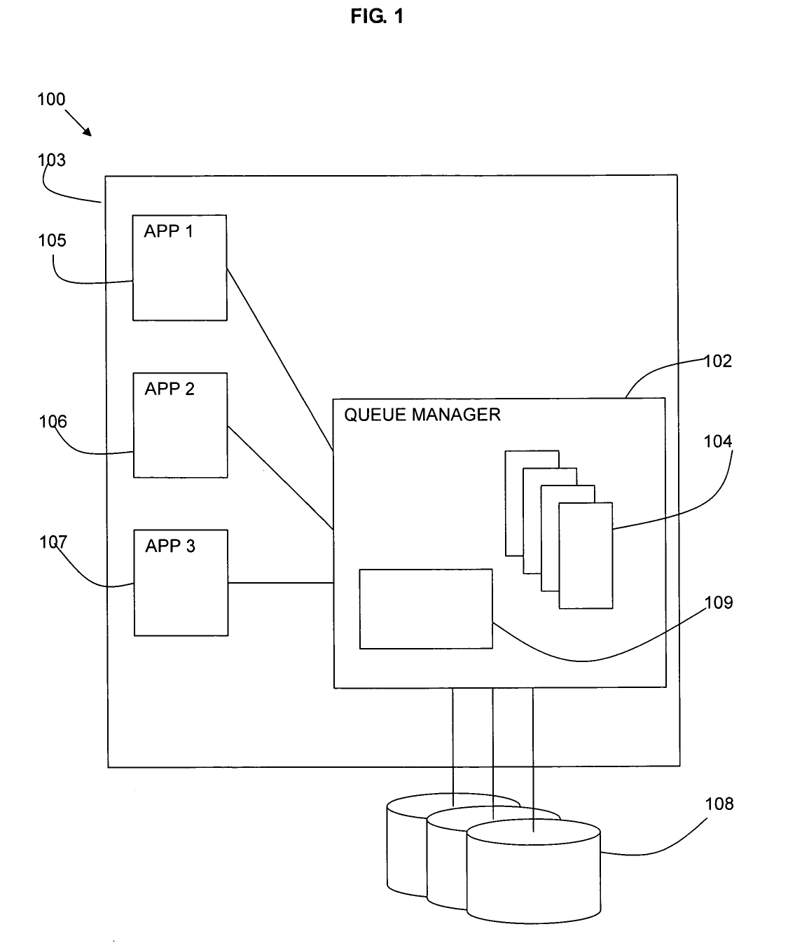

FIG. 1 shows a schematic representation of a messaging system 100. The messaging system 100 has a queue manager 102 which manages local queues 104 for applications 105, 106, 107 running within a single processor environment 103. The queue manager 102 owns and manages resources 108 which are used by the messaging system 100. The resources 108 include page sets that hold object definitions and message data, logs for recovering messages in the event of a queue manager failure, processor storage, and connections through which different application environments can access the queue manager 102. The queue manager 102 also includes a channel initiator 109 which enables the queue manager 102 to send and receive messages to and from queues managed by other queue managers enabling distributed queuing. The channel initiator 109 sets up communication links between the queue managers.

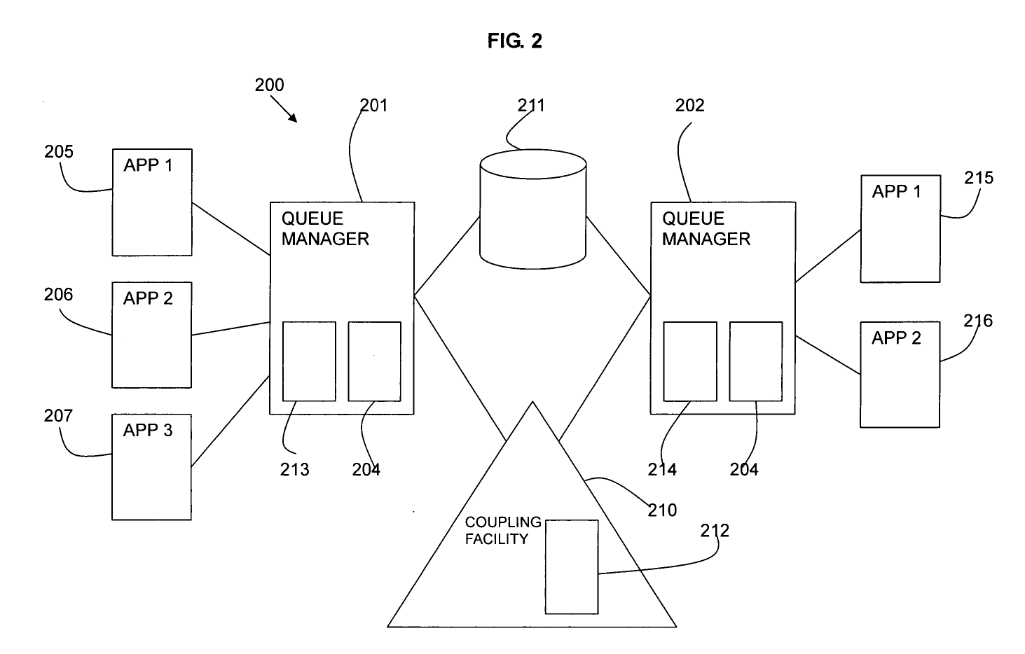

FIG. 2 shows a messaging system 200 in which a plurality of queue managers share queues. A group of queue managers can form a queue sharing group in which the queue managers all have access to one or more shared message queues to enable parallel processing of messages by application programs connected to any one of the queue managers in the queue sharing group.

FIG. 2 shows a first queue manager 201 with local applications 205, 206, 207 and a second queue manager 202 with local applications 215, 216. The first and second queue managers 201, 202 belong to a queue-sharing group which means that they can access the same set of shared queues 204. A message can be put on a shared queue 204 on one queue manager 201 and retrieved from the queue 204 on a different queue manager 202. This provides a rapid mechanism for communication within a queue-sharing group that does not require channels to be active between queue managers 201, 202.

The messages on a shared queue 204 are stored on list structures 212 in a coupling facility 210. The definition of a shared queue 204 and other object definitions are stored in a shared data repository 211. All queue managers 201, 202 in a queue-sharing group may also maintain their own logs and page sets to use non-shared local queues 213, 214.

In addition to queue-sharing groups, queue managers can be grouped in a cluster such that they can make the queues that they host available to every other queue manager in the cluster. Any queue manager can send a message to any other queue manager in the same cluster without the need for many of the object definitions required for standard distributed queuing. Each queue manager in the cluster has a single transmission queue from which it can transmit messages to any other queue manager in the cluster.

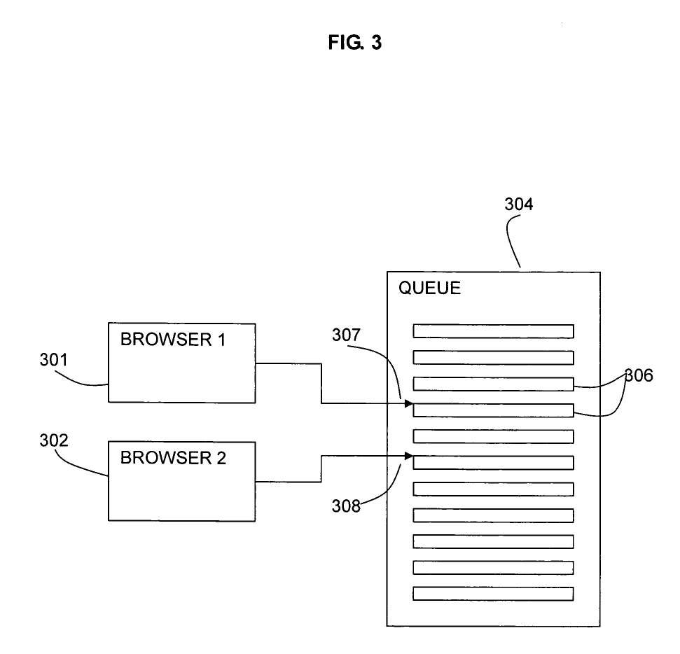

A queue may be provided by any of the above arrangements, which can be browsed by more than one application in order to scan the messages held in a queue. FIG. 3 shows a queue 304 containing a plurality of data items, which in this case are messages 306. First and second browsers 301, 302 are shown browsing the queue 304 simultaneously. Each browser 301, 302 has a cursor 307, 308 which is a logical pointer to messages 306 on the queue.

Browsing messages on a queue in WebSphere MQ is carried out by an application using the Messaging Queue Interface to call its local queue manager using the MQGET call as follows:
1. Call MQOPEN to open the queue for browsing, specifying the MQOO_BROWSE option.
2. To browse the first message on the queue, call MQGET with the MQGMO_BROWSE_FIRST option. To find a particular message selection criteria such as message id, correlation id, group id, message token may be specified. Use call MQGET repeatedly with the MQGMO_BROWSE_NEXT option to step through many messages.
3. Call MQCLOSE to close the queue.

When a queue is opened with the MQOO_BROWSE option, a browse cursor is established, positioned logically before the first message on the queue. More than one browse cursor can be active from a single application. More than one browse cursor can also be active from multiple applications scanning the same queue. When an MQGET call is made for browsing, one of the following options can be specified to retrieve messages from the queue non-destructively.

MQGMO_BROWSE_FIRST—This option gets a copy of the first message on a queue that satisfies the conditions specified in a message descriptor structure. The previous position of the browse cursor is ignored. The message remains on the queue and the browse cursor is positioned on this message.

MQGMO_BROWSE_NEXT—This option gets a copy of the next message that satisfies the conditions specified in the message descriptor structure. The browse cursor browses from the current position in the queue to the next message on the queue that satisfies the selection criteria. Again, this option does not remove a message from the queue and is used to read the messages sequentially in the queue.

MQGMO_MSG_UNDER_CURSOR—This option can subsequently be used with a non-browse MQGET call to remove the message from the queue.

MQGMO_LOCK—This option locks the message that is browsed, so that the message becomes invisible to any other handle open for the queue. Only one message can be locked per queue handle.

There are instances where messages can be skipped by a browse. These include:
A new message is put with a higher priority than the current message being browsed.
A message is locked by another handle using MQGMO_LOCK.
An uncommitted message, which is in the process of being put on a queue. Messages within a unit-of-work cannot be browsed until the unit-of-work is committed.
A committed message is being got by another unit-of-work but the unit-of-work rolls back returning the message to the queue.

Skipped messages will not be seen unless the MQGMO_BROWSE_FIRST option is used to work though the queue again. However, this will also return messages that have previously been seen.

A marker that indicates the data items in a list of data items which have been browsed by a particular browser may be provided. The identified browsers may be different application browsers or different browse instances within a single application. Different browsers are referred to as browse handles.

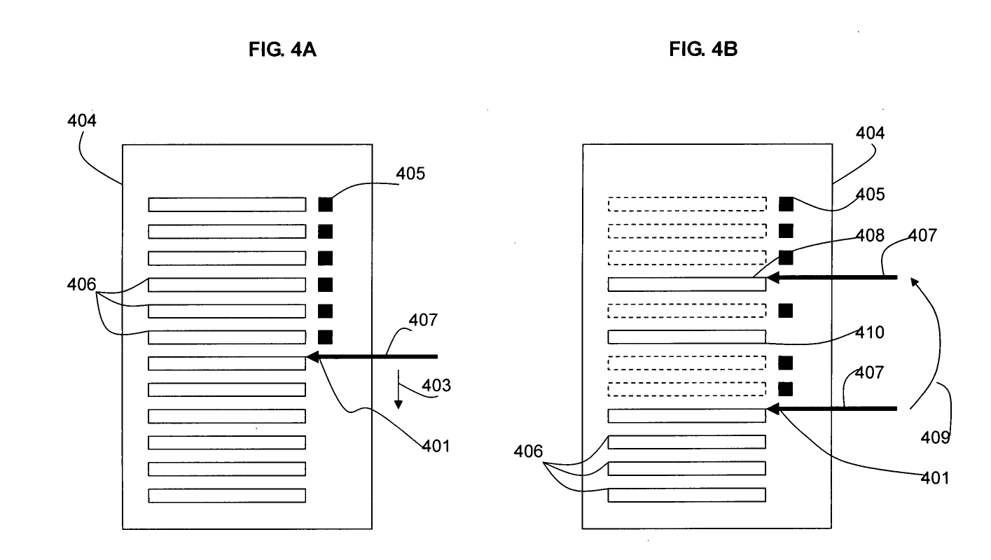

According to one aspect of the present invention, a marker indicates that a particular browse handle has browsed a message. A different mark is used for each browse handle. Referring to FIGS. 4A and 4B, a list of data items 404 (which may be, for example, a message queue) is shown with a plurality of data items 406. In FIG. 4A, a cursor 407 points to a first position 401 in the list 404 which is the position to which a browse handle has browsed. The browse handle is browsing through the list in the direction shown by arrow 403. Each data item 406 that has been browsed by the browse handle is marked with an identifying mark 405.

FIG. 4B shows new data items 408 and 410 added to the list above the current first position 401 of the cursor 407. The cursor 407 rescans the list getting unmarked data items. The cursor 407 jumps back 409 to the newly added data item 408 which is unmarked. Having browsed the new data item 408, the browse handle can identify from the marks 405 which data items 406 it has already seen and as it can see the second new item 410. It browses the second new item 410 before returning to the first position 401 to continue browsing.

The following is an implementation using options that are added to WebSphere MQ messaging. A mechanism is provided to allow an individual open handle that is browsing a queue to mark messages at the object handle level. A mechanism is provided to allow an open handle to request on a subsequent call to MQGET that messages are only returned if they are not marked for that open handle.

There is provided a first new get message option to mark messages browsed by a browse handle. After a successful call to MQGET that specifies this option, the message that is returned, or that is identified by the message token that is returned, is considered by the object handle used in the call to be marked. The message is not removed from the queue.

This option is only valid if one of the following MQGMO options is also specified:
MQGMO_BROWSE_FIRST;
MQGMO_BROWSE_NEXT;
MQGMO_BROWSE_MSG_UNDER_CURSOR.

There is provided a second new get message option to browse messages that are unmarked. A call to MQGET that specifies this option will not return a message that is already considered to be marked by this handle.

There is provided a third new get message option to unmark a message that has previously been marked. After a call to MQGET that specifies this option, the message located is no longer considered to be marked by this handle.

An application may wish to browse all the messages on a queue in the order that they would be returned to a destructive MQGET. Such an application would use the get message options to browse from the first message in a queue with the second new option to browse unmarked messages and the first new option to mark the browsed messages for the browse.

Repeated calls to MQGET with these options would return each message on the queue in turn. If MQRC_NO_MSG_AVAILABLE is returned, then at the time when the call was initiated, there were no messages on the queue that have not been browsed and that satisfied any match options supplied.

Although browses are normally sequential, the browse marks can also be used with non-sequential browses where match options are used to specify which messages are to be located. It is possible to use both sequential and non-sequential options within the same browse handle.

Data items which have been marked under one context can be removed from a list under another context as the data item is only not returned for subsequent browses within the first context. This allows one application to pass a reference to a data item to another application which will then process the data item and for the data item to be logically removed from the first context's view of the list.

When a data item's content is updated, all the marks associated with it are removed. This enables all browsers to see the data item again. In the example of WebSphere MQ messaging systems, one possible update to a message is the Rollback count which is updated when a unit-of-work doing a destructive get Rolls back. This implies a failure of the process dispatched to deal with the message and so the message must be re-dispatched or a clean up process invoked.

In an example in which the list of data items is a database, updates are very common. An option associated with a browse handle or group of browse handles that controls whether or not marks should be released when an item is updated may be included. Some applications may wish to see new and changed items whilst others are not interested in seeing updated items again.

A group of browse handles may cooperate with one another. In another aspect of the present invention, a marker can be used to identify data items that have been browsed by a group of cooperating browse handles either in addition to or instead of markers for particular browse handles.

Additional marks can be provided for groups of cooperating browse handles. Each browser can have its own mark which indicates data items which they have personally seen. There can also be a group mark. Each time a member of the group browses a data item, it marks that data item with its own mark and also with a group mark. This enables individual browse handles to browse data items which they themselves have not previously seen and to browse data items which have not been seen by another member of a cooperative group.

It would be possible to use the group mark only; however, the advantage of using personal marks as well is that a member of the group may not be able to deal with a data item that they have browsed and would prefer that another browse handle deal with the item. The first browse handle can mark the data item but leave it unmarked for the group so that one of the other group members can deal with the data item.

In the WebSphere MQ messaging environment, a mechanism is provided to allow an open handle that is browsing a queue in a cooperative manner to mark messages for all handles that are cooperating with it. There is provided an open option to identify a cooperative group. This indicates that the object handle returned by MQOPEN will be considered to be part of a cooperative set of handles. This option is provided in addition to the MQOO_BROWSE option.

There is also provided a first new get message option to mark messages browsed by a any one of the cooperative set of browse handles. After a successful call to MQGET that specifies this option, the message that is returned, or that is identified by the message token that is returned, is considered by any object handle that is part of the cooperating set of handles, to be marked for the cooperating set of handles.

If a message is marked for a cooperative group, the message is not considered to be marked for each individual handle in the set at a handle level. That is, this is not exactly equivalent to each handle in the cooperative group browsing the message with the individual marking option, but all handles in the set can determine that the message has been marked. The message is not removed from the queue.

This first new get option for a group is only valid if the object handle used was returned by a successful call to MQOPEN that specified the option identifying the group and one of the following get message options is also specified:
MQGMO_BROWSE_FIRST;
MQGMO_BROWSE_NEXT;
MQGMO_BROWSE_MSG_UNDER_CURSOR.

There is also provided a second new get message option for a cooperative group to unmark messages previously marked for a particular specified cooperative group. After a call to MQGET that specifies this option, the message located is no longer considered by all other open handles in the set of cooperating handles to be marked for the cooperating set. It is still considered to be marked at handle level by any open handle that considered it to be marked at handle level before this call.

This call is only valid using an open handle that was returned from a successful call to MQOPEN with the option identifying the cooperative group. This call should succeed even if the message is not considered to be marked by the cooperative group.

In another aspect of the present invention, once a data item has been browsed by any browse handle, it is marked and not returned for browsing by any browse handle. In this way, data items can be hidden from all browse handles once they have been browsed once by any browse handle. In other words, this is equivalent to the cooperating group of browse handles including all the browse handles browsing a list of data items. The only options that are needed are to mark, unmark and to get a marked item.

This may be applied to a messaging queue with multiple dispatchers for allocating messages to other processing applications. Multiple messages on a queue can be marked as browsed by any browse handle. The browse handle that scans a particular message can designate the get responsibility to a processing application. The processing application can get the marked message using a unique key for the message such as the message token.

Each browse handle could individually maintain a list of messages marked by the handle. There may also be another list for the messages globally marked by cooperating browse handles.

A single bit map may be maintained for a queue which indicates which handles have marked a message. As well as providing a single entry to be maintained, additional browse handles require minimal additional storage (8 handles/byte). A bit map is a data structure in memory that represents information in the form of a collection of individual bits and is used as a representation indicating which data items have a marker. Each location in the bit map for a data item represents a particular browser and can have a mark (1) indicating that it has been seen and marked by that browser or no mark (0) indicating that it has not been seen and hence not marked.

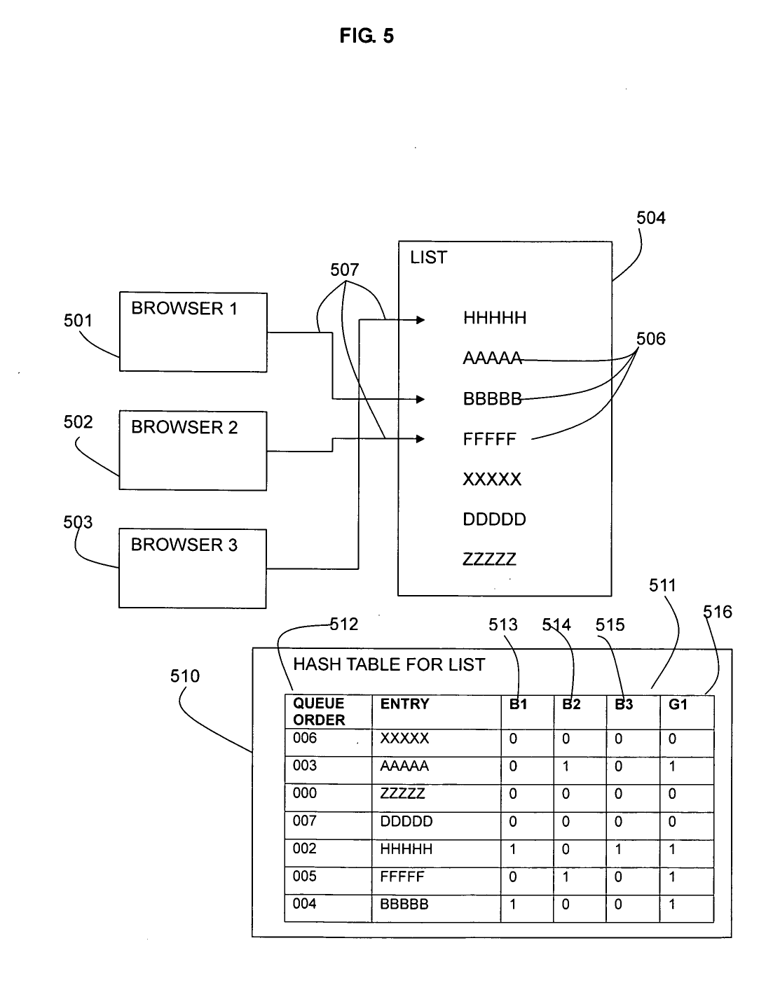

The bit map structure can be held in a hash table, a binary tree or another form of data structure. FIG. 5 shows a list 504 with data items 506. Three browse handles B1, B2, B3, 501, 502, 503 are browsing the list 504 simultaneously. Each browse handle 501, 502, 503 has a cursor 507 logically pointing to the position in the list which each browse handle has reached. A simplified hash table 510 is shown as it would be maintained for the list 504. The hash table 510 includes a bit map 511 which indicates which browse handles have marked a data item 506. Each data item 506 is stored in the hash table 510 with a queue order chain 512 with associated bit references for each browse handle B1, B2, B3, 513, 514, 515.

The bit map 511 also indicates a marker for a group of cooperative browse handles G1 516. The cooperative group G1 is formed of browse handles B1 and B2, 501, 502 and so if either B1 or B2 has browsed a data item, the corresponding entry in the hash table 510 has a bit reference.

Data items 506 in the form of messages can be identified by message tokens in the hash table 510. A message token is used to identify uniquely an instance of a message on a queue. Other forms of data items can similarly be identified by references such as headers or tokens.

As an example, the following method is used to create and maintain a hash table for a list of data items in the form of a private queue. In a browsing operation with no match criteria specified, searching is started from the beginning of a queue. For the first unlocked message found, an entry is created in the hash table using the message token and marking it for the individual browse handle and/or globally for a cooperative group of browse handles. The table entries are chained together in queue order within priority or order of the queue. For locked messages, an entry is also created and chained but not marked. This enables messages that subsequently become available prior to the point reached by the browse to be detected.

On subsequent browse requests from the same or a different browse handle, the queue order chain of message token entries is used to run through the previously browsed messages looking for messages that have not yet been marked. This avoids the need to go into a buffer manager of the queue manager. Only when the end of the chain for a priority is reached will the buffer manager chains need to be looked at to see if there are any new or not yet browsed messages to be considered and added to the queue order chain.

To avoid the overhead of re-scanning the chain each time, each browse handle maintains two cursors. In addition to the existing browse cursor, a low water mark (LWM) cursor is provided to indicate the point from which the queue must be rescanned. The LWM cursor consists of a message token and the message priority. An indicator is also provided as to whether the browse handle is using the cooperative browse option. The LWM cursors for all browse handles are chained from the hash table header.

As the queue is browsed and the queue order chain is built, the LWM is updated until the first uncommitted put message is reached. The LWM is not updated further as a scan is carried out for an unmarked message. On subsequent requests to “get first unmarked” message, the scanning can start scanning from the LWM and, if the message is now committed, the LWM can be updated as before until the next uncommitted message is reached. If the LWM message no longer exists in the hash table, the LWM is reset and the scan is restarted from the beginning of the queue.

When using match criteria in a browsing operation the appropriate index can be used to find the first eligible message. The associated hash table is entry is located using the message token. If it exists and is not already marked, it is updated to mark the message. If it is already marked the process is repeated for the next message on the match criteria synonym chain. If a hash table entry does not exist, one is created but it is not chained to the queue order chain since the correct position cannot easily be determined.

For a non-indexed queue the same procedure could be adopted as above using the existing matching logic to find the correct message by searching through the buffer manager pages to find the correct message.

The message token hash table is created by the first open call with the cooperative option or the first browse request with a handle marked option. At the same time the interval processor task will be created. The hash table header will contain a bit map showing which browse handles are free/in use. A browse handle will be assigned the first free slot in the bit map.

When a browse handle is closed, its slot will not be immediately marked as free. Instead, the corresponding slot in a closed handle bit map in the table header will be set so that the interval processor can clean up and then mark the slot as free. The LWM cursor can be freed at browse handle close. The entire hash table structure will only be deleted when the last queue browse handle is closed.

Periodically, the interface processor task wakes up to release long held global marks and handle marks for closed handles. The wake up interval can be fixed or may be a queue manager, queue or handle attribute.

In a messaging environment in which the list of data items is a shared queue, the above method of creating and maintaining a hash table is altered accordingly. The main problem with shared queues is how to let other members of the queue sharing group know what is happening. Everything has to be communicated through the coupling facility; however, to keep performance levels, an excessive number of coupling facility calls should be avoided.

In most cases, the number of concurrent browse handles will be fairly small, for example, less than ten on a queue manager. A fixed size of bit map can be used to implement expected numbers of browse handles. However, the hash table could cope with an unlimited number by assigning each handle a number and dividing the number by the number of entries in the bit map. The quotient would indicate which map extent was required and the remainder to index within the map.

Since there are multiple processes such as browse handles, getters, putters and interval processors all accessing the hash table in different ways, serialisation techniques are needed to ensure that users of the table are protected from each other.

The block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of browsing a list of data items, the method comprising:
scanning through a list of data items;
providing a marker to data items once they have been scanned, the marker providing an indication that a respective data item has been scanned by a given browse entity; and
subsequently scanning through only unmarked data items in the list of data items.

2. The method of claim 1, wherein providing a marker to data items once they have been scanned comprises hiding at least one of scanned the data items from the browse entity.

3. The method of claim 1, wherein the given browse entity is a browse mechanism carrying out the scanning.

4. The method of claim 1, wherein the given browse entity is a cooperating group of browse mechanisms.

5. The method of claim 1, wherein scanning a list of data items comprises scanning references to the data items.

6. The method of claim 1, further comprising unmarking at least one of the data items on request.

7. The method of claim 1, wherein the list of data items is scanned sequentially.

8. The method of claim 1, wherein the list of data items is scanned by matching criteria.

9. The method of claim 1, further comprising creating and maintaining a bit map for the list of data items indicating the markers for the data items in the list for each browse entity.

10. The method of claim 1, further comprising providing a first cursor as a logical pointer to the position of scanning in the list of data items and providing a second cursor as a logical pointer to the point from which the list must be rescanned.

11. The method of claim 1, further comprising releasing the markers after a given interval.

12. The method of claim 1, wherein the list of data items is a messaging queue.

13. An apparatus for browsing a list of data items, the apparatus comprising:
a browse mechanism to scan a list of data items;
a marker applied to data items once they have been scanned by the browse mechanism, the marker providing an indication that a respective data item has been scanned by a given browse entity; and
the browse mechanism subsequently scanning only unmarked data items in the list of data items.

14. The apparatus of claim 13, wherein the data items to which a marker is applied are hidden from the given browse entity.

15. The apparatus of claim 13, wherein the given browse entity is the browse mechanism carrying out the scanning.

16. The apparatus of claim 13, wherein the given browse entity is a cooperating group of browse mechanisms.

17. The apparatus of claim 13, wherein the browse mechanism scans references to the data items.

18. The apparatus of claim 13, wherein the apparatus unmarks a data item on request by the browse mechanism.

19. The apparatus of claim 13, wherein the browse mechanism scans the list of data items sequentially.

20. The apparatus of claim 13, wherein browse mechanism scans the list of data items by matching criteria.

21. The apparatus of claim 13, further comprising a bit map (511) for the list of data items indicating the markers for the data items in the list for each browse entity.

22. The apparatus of claim 13, further comprising a first cursor as a logical pointer to the position of scanning in the list of data items by the browse mechanism and a second cursor as a logical pointer to the point from which the list must be rescanned.

23. The apparatus of claim 13, wherein the apparatus releases the markers after a given interval.

24. The apparatus of claim 13, wherein the list of data items is a messaging queue.

25. A computer program product comprising:
a computer readable medium having computer readable program code embodied therein, the computer readable program code comprising:
computer readable program code configured to scan through a list of data items;
computer readable program code configured to provide a marker to data items once they have been scanned, the marker providing an indication that a respective data item has been scanned by a given browse entity; and
computer readable program code configured to scan subsequently through only unmarked data items in the list of data items.

26. The computer program product of claim 25, wherein the computer readable program code configured to provide a marker to data items once they have been scanned comprises computer readable program code configured to hide at least one of scanned the data items from the browse entity.

27. The computer program product of claim 25, wherein the computer readable program code configured to scan through a list of data items comprises computer readable program code configured to scan references to the data items.

28. The computer program product of claim 25, further comprising computer readable program code configured to unmark at least one of the data items on request.

29. The computer program product of claim 25, wherein the list of data items is scanned sequentially.

30. The computer program product of claim 25, wherein the list of data items is scanned by matching criteria.

31. The computer program product of claim 25, further comprising computer readable program code configured to create and maintain a bit map for the list of data items indicating the markers for the data items in the list for each browse entity.

32. The computer program product of claim 25, further comprising computer readable program code configured to provide a first cursor as a logical pointer to the position of scanning in the list of data items and computer readable program code configured to provide a second cursor as a logical pointer to the point from which the list must be rescanned.

33. The computer program product of claim 25, further comprising computer readable program code configured to release the markers after a given interval.

34. The computer program product of claim 25, wherein the list of data items is a messaging queue.
